(19) United States
(12) Patent Application Publication
(10) Pub. No.: US 2021/0112141 A1
(43) Pub. Date: Apr. 15, 2021

(54) SELECTING A CLOUD SERVICE PROVIDER FOR DEPLOYING A CLOUD SERVICE

(71) Applicant: HEWLETT PACKARD ENTERPRISE DEVELOPMENT LP, Houston, TX (US)

(72) Inventor: Shrinath Vasudevamurthy Honnavalli, Bangalore (IN)

(21) Appl. No.: 16/601,911

(22) Filed: Oct. 15, 2019

(51) Int. Cl. H04L 29/08; H04L 12/24

(52) U.S. Cl. CPC H04L 67/327; G06F 9/455; H04L 41/0866; H04L 67/10

(57) ABSTRACT

Examples described relate to selection of a cloud service provider for deploying a cloud service. In an example, a user request for deploying a cloud service on a cloud system may be received. Based on configuration information specified in the user request, a least cost cloud service provider capable of deploying the cloud service may be identified. In response to a user selection, the least cost cloud service provider for deploying the cloud service may be selected. At a future time, a determination may be made whether an alternate cloud service provider is capable of offering the cloud service at a further lower cost. In response to the determination, an option to select the alternate cloud service provider for deploying the cloud service may be provided. In response to a user selection, the alternate cloud service provider for deploying the cloud service may be selected.

### BACKGROUND

The advent of cloud-based computing architectures has opened new possibilities for businesses. As a result, an increasing number of enterprises are adopting cloud computing based solutions. Generally speaking, cloud computing involves delivery of computing as a service rather than a product, whereby shared resources (software, storage resources, etc.) are provided to computing devices as a service. The resources are shared over a network such as the internet. Cloud computing thus provides quick and scalable access to computing resources and information technology (IT) services.

### BRIEF DESCRIPTION OF THE DRAWINGS

For a better understanding of the solution, examples will now be described, with reference to the accompanying drawings, in which:

FIG. 1 is a block diagram of an example computing environment to select a cloud service provider for deploying a cloud service;

FIG. 2 is a block diagram of an example system to select a cloud service provider for deploying a cloud service;

FIG. 3 is a flowchart of an example method of selecting a cloud service provider for deploying a cloud service;

FIG. 4 is a flowchart of an example method of selecting a cloud service provider for deploying a cloud service; and

FIG. 5 is a block diagram of an example system including instructions in a machine-readable storage medium to select a cloud service provider for deploying a cloud service.

### DETAILED DESCRIPTION

Cloud computing is a delivery model for technology-enabled services that provides on-demand and pay-as-you-use access to an elastic pool of shared computing resources. Some examples of such resources may include applications, servers, storage, networks, etc. Cloud computing allows rapid provisioning of computing resources that could be scaled up or down depending on the requirements of a customer. Thus, these assets may be consumed “as a service”.

One of the reasons behind the success of cloud computing is a technology called virtualization. Virtualization allows creation of a virtual version of a resource such as an operating system, a hardware platform, a storage resource etc. which may be shared, for instance, among different clients. Multiple virtual machines (VMs) may be created on a host device (for example, a server). Another type of virtualization may include container technology, which may include container orchestrator and deployment of containerized applications for example.

A cloud service deployed on a cloud system may be charged to a user, for example, on a per-hour basis. When cloud services are created but not fully used or not removed when unused, it may lead to unnecessary operational costs for an organization. Many cloud service creation requests typically come with an expiry date, which get automatically extended post expiry without a due review. This results into an inefficient process since extension requests are not considered as opportunities to identify and select a technically and/or operationally (e.g., cost) more efficient cloud service provide compared to the incumbent service provider.

To address these technical challenges, the present disclosure describes various examples for selecting a cloud service provider for deploying a cloud service. In an example, a user request for deploying a cloud service on a cloud system may be received. Based on configuration information specified for the cloud service in the user request, a least cost cloud service provider capable of deploying the cloud service may be identified. In response to a user selection, the least cost cloud service provider for deploying the cloud service may be selected. At a future time, a determination may be made whether an alternate cloud service provider is capable of offering the cloud service at a further lower cost. In response to a determination that the alternate cloud service provider is capable of offering the cloud service at a further lower cost, an option to select the alternate cloud service provider, for deploying the cloud service, may be provided. In response to a user selection, the alternate cloud service provider may be selected for deploying the cloud service.

The disclosure described herein provides a technical solution to select an efficient cloud service provide for deploying a cloud service.

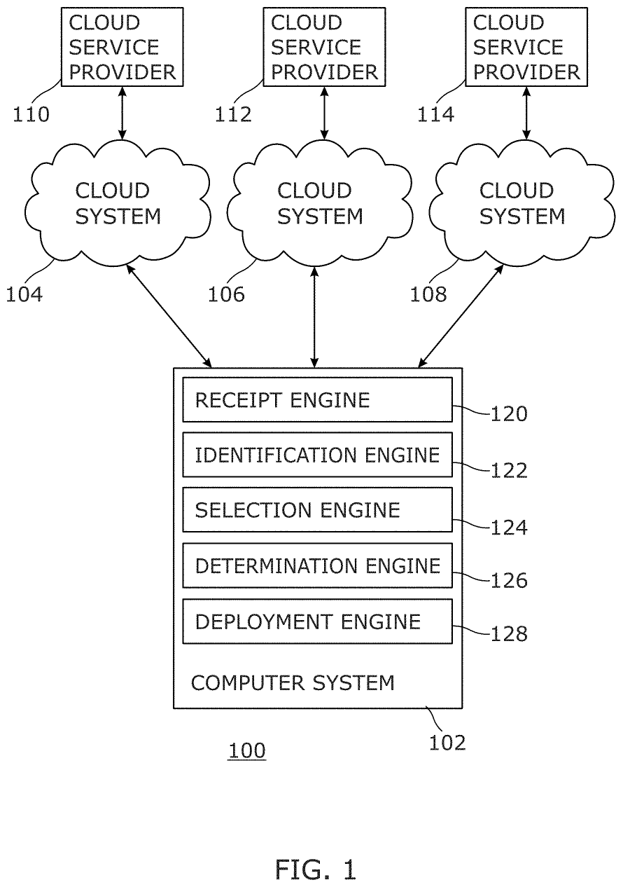

FIG. 1 is a block diagram of an example computing environment 100 to select a cloud service provider for deploying a cloud service. In an example, computing environment 100 may include a computing system 102, cloud systems 104, 106, and 108. Although one computing system and three cloud systems are shown in FIG. 1, other examples of this disclosure may include more than one computing system and more or less than three cloud systems. In an example, each of the cloud systems 104, 106, and 108 may be provided by a separate cloud service provider. For example, cloud systems 104, 106, and 108 may be provided by cloud service providers 110, 112, and 114, respectively.

In an example, computing system 102 may represent any type of computing device capable of reading machine-executable instructions. Examples of the computing device may include, without limitation, a server, a desktop computer, a notebook computer, a tablet computer, a thin client, a mobile device, and the like.

As used herein, the term “cloud system” (or “cloud”) may refer to an on-demand network access to a shared pool of information technology resources (e.g., networks, servers, storage, and/or applications) that can be quickly provisioned. A cloud system (e.g., 104, 106 or 108) may include a public cloud (or a public cloud system), a private cloud (or a private cloud system), or a hybrid cloud (or a hybrid cloud system). To explain briefly, a cloud may be termed a public cloud if cloud computing services are rendered over a public network such as the internet. On the other hand, a private cloud is a proprietary network that supplies services to a specific set of users. A hybrid cloud combines private and public cloud services.

In an example, each of the cloud systems 104, 106, and 108 may include resources. As used herein, the “resources” in each of the cloud systems 104, 106, and 108 may refer to software resources (machine-executable instructions) or hardware resources. These may include, for example, computing resources, network resources, and/or storage resources. Computing resources may be a hardware computing resource (e.g., includes at least one processor). The hardware computing resource may represent any type of system capable of reading machine-executable instructions. Examples of the hardware computing resource may include a server, a desktop computer, a notebook computer, a tablet computer, a thin client, a mobile device, a personal digital assistant (PDA), and the like. In an example, computing resources may represent software resources (machine-executable instructions). The software resources may include, for example, operating system software, firmware, and application software. Other examples of the software resources may include virtual machines, virtual servers, load balancers, firewalls, container orchestration, etc. In an example, computing resources may be a combination of hardware and software resources.

Network resources may include a network device, a network software, or any combination thereof. Some non-limiting examples of the network device may include a hub, a network switch, a network router, a virtual switch, and a virtual router.

Storage resources may include a storage device, a storage software, or any combination thereof. The storage device may be an internal storage device, an external storage device, or a network attached storage device. Other examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In other examples, the storage device may be a Direct Attached Storage (DAS) device, a Network Attached Storage (NAS) device, a Redundant Array of Inexpensive Disks (RAID), a data archival storage system, or a block-based device over a storage area network (SAN).

As used herein, the term “cloud service” may refer to any information technology (IT) service that is provisioned and accessed from a cloud service provider. For example, it may include delivery of resources, such as those highlighted above, over a network (e.g., the Internet). The resources may be accessed by users (for example, via computing system 102) or by applications. In an example, each of the cloud systems 104, 106, and 108 may provide or deploy various types of cloud services. These services may include, for example, Infrastructure as a Service (IaaS), Platform as a Service (PaaS), and Software as a Service (SaaS).

In an example, a cloud service may include provisioning of a software container. Software containers may provide a mechanism to securely run an application in an isolated environment, which may be packed with all its dependencies and libraries. A software container thus may include an entire runtime environment: an application, its dependencies, libraries, and configuration files that may be bundled into one package. Such an application package may be referred to as a “containerized application” or “container application”. Since an application may be run in an environment that the application expects, software containers may simplify testing and deployment of an application. In another example, a cloud service may include provisioning of a virtual machine.

In an example, in a cloud system (e.g., 104, 106, or 108), cloud resources (like servers and storage) may be owned and operated by a third-party cloud service provider and delivered over a network (e.g., the Internet). In an example, if any of the cloud system (e.g., 104, 106, or 108) is a public cloud system, cloud resources may be shared with other organizations. In an example, one or more of the cloud systems (e.g., 104, 106, or 108) may be a hybrid cloud system.

In an example, computing system 102 may be communicatively coupled with cloud systems 104, 106, and/or 108, for example, via a computer network. The computer network may be a wireless or wired network. The computer network may include, for example, a Local Area Network (LAN), a Wireless Local Area Network (WAN), a Metropolitan Area Network (MAN), a Storage Area Network (SAN), a Campus Area Network (CAN), or the like. Further, the computer network may be a public network (for example, the Internet) or a private network (for example, an intranet).

In an example, computing system 102 may include a receipt engine 120, an identification engine 122, a selection engine 124, a determination engine 126, and a deployment engine 128.

Engines 120, 122, 124,126, and 128 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one of engines 120, 122, 124, 126, and 128. In some examples, the at least one machine-readable storage medium may store instructions that, when executed by the at least one processing resource, at least partially implement some or all of engines 120, 122, 124, 126, and 128. In such examples, the computing system 102 may include the at least one machine-readable storage medium storing the instructions and the at least one processing resource to execute the instructions. In an example, computing system 102 may be any combination of hardware and programming.

In an example, receipt engine 120 on computing system 102 may receive a user request for deploying a cloud service on a cloud system. In an example, the user request may be received via a user interface of a cloud management platform (not shown). In an example, the user request may include a type of cloud service desired by a user. In an example, the cloud service may include provisioning of a software container. In another example, the cloud service may include provisioning of a virtual machine, a container, or other type of virtualization. The cloud service may be of the type, for example, Infrastructure as a Service (laaS), Platform as a Service (PaaS), and Software as a Service (SaaS).

In an example, a user may specify configuration information related to the cloud service in the user request. In an example, the configuration information may specify a type of resource(s) desired by a user. These resources may include, for example, processing resources, network resources, and storage resources.

In response to a receipt of a user request by receipt engine 120, identification engine 122 may identify, based on the configuration information specified in the user request, a least cost cloud service provider that is capable of deploying the cloud service. For example, referring to FIG. 1, based on the configuration information specified in the user request, identification engine 122 may identify a least cost cloud service provider among cloud service providers 110, 112, and 114. In an example, the identification may include a comparison of the configuration information in the user request with configuration information of cloud services offered by various cloud service providers (e.g., 110, 112, and 114). In response to the comparison, a least cost cloud service provider that is capable of deploying the cloud service, considering the configuration information in the user request, may be identified amongst cloud service providers 110, 112, and 114. In an example, the least cost cloud service provider may be a public cloud service provider or a private cloud service provider.

Once the least cost service provider is identified, an option may be given, for example, via a user interface of a cloud management platform, to select the least cost cloud service provider. In response to a user selection to that effect, selection engine 124 may select the least cost cloud service provider for deploying the cloud service. In an example, once the selection is made, the cloud service provider may be notified, who may proceed with the deployment of the cloud service on its cloud system. For example, referring to FIG. 1, if cloud service provider 112 is identified as the least cost cloud service provider amongst cloud service providers 110, 112, and 114, selection engine 124 may select it for deploying the cloud service. The cloud service provider 112 may then deploy the cloud service on its cloud system 106.

At a future time period, determination engine 126 may determine whether an alternate cloud service provider is available that could provide the same cloud service at a further lower cost (i.e. at a cost less than the cost of deploying the cloud service on the current cloud service provider). In an example, determination engine 126 may perform this determination at a time prior to the expiry of the cloud service deployed by the least cost cloud service provider. In another example, determination engine may perform this determination at a time after the expiry of the cloud service deployed by the least cost cloud service provider. In an example, a future time period may include a periodic time period. Examples of the periodic time period may include a weekly time period, a monthly time period, a half-yearly time period, and a yearly time period.

In an example, the aforementioned determination by determination engine 126 may comprise determining a cost of transferring the cloud service to the alternate cloud service provider and whether the cost of transferring the cloud service to the alternate cloud service provider is lower than the cost of deploying the cloud service by the least cost service provider. In an example, the cost of transferring the cloud service to the alternate cloud service provider may include a cost of cancelling the cloud service on the least cloud service provider and a cost of deploying the cloud service by the alternate cloud service provider.

In response to a determination that the alternate cloud service provider is capable of offering the cloud service at a further lower cost, deployment engine 128 may provide an option to select the alternate cloud service provider for deploying the cloud service. In an example, the option may be provided to a user via a user interface, for example, of a cloud management platform. In an example, the alternate cloud service provider may be a public cloud service provider or a private cloud service provider.

In response to a user selection, selection engine 124 may select the alternate cloud service provider for deploying the cloud service. In an example, once the selection is made, the current cloud service provider may be notified, which may undeploy the cloud service on its cloud system. For example, referring to FIG. 1, if cloud service provider 114 is identified as the alternate cloud service provider, selection engine 124 may select cloud service provider 114 for deploying the cloud service. The cloud service by current cloud service provider 112 may be cancelled, and a cloud service with a similar configuration may be deployed on cloud system 108 of cloud service provider 114.

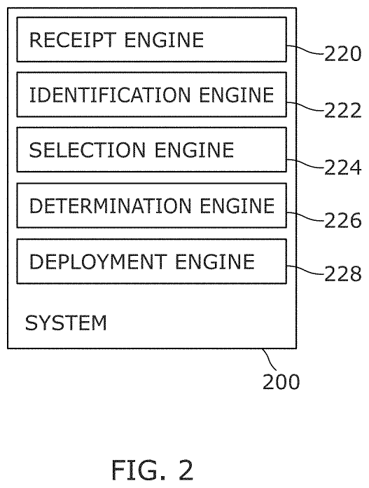

FIG. 2 is a block diagram of an example computing system 200 to select a cloud service provider for deploying a cloud service. In an example, computing system 200 may be analogous to the computing system 102 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, computing system 200 may include a receipt engine 220, an identification engine 222, a selection engine 224, a determination engine 226, and a deployment engine 228. In an example, receipt engine 220, identification engine 222, selection engine 224, determination engine 226, and deployment engine 228 may perform functionalities similar to those described earlier in reference to receipt engine 120, identification engine 122, selection engine 124, determination engine 126, and deployment engine 128 of FIG. 1, respectively.

In an example, receipt engine 220 may receive a user request for deploying a cloud service on a cloud system. Identification engine 222 may identify, based on configuration information specified for the cloud service in the user request, a least cost cloud service provider capable of deploying the cloud service. In response to a user selection, selection engine 224 may select the least cost cloud service provider for deploying the cloud service. Determination engine 226 may determine, at a future time, whether an alternate cloud service provider is capable of offering the cloud service at a further lower cost. In response to a determination that the alternate cloud service provider is capable of offering the cloud service at the further lower cost, deployment engine 228 may provide an option to select the alternate cloud service provider for deploying the cloud service. In response to a user selection, selection engine 224 may select the alternate cloud service provider for deploying the cloud service. In an example, determination engine 226 may be initiated at the instance of a user, based on offers given out by various cloud service providers. Based on the user input, the determination engine may determine if the promotional offer by a cloud service provider is beneficial or not.

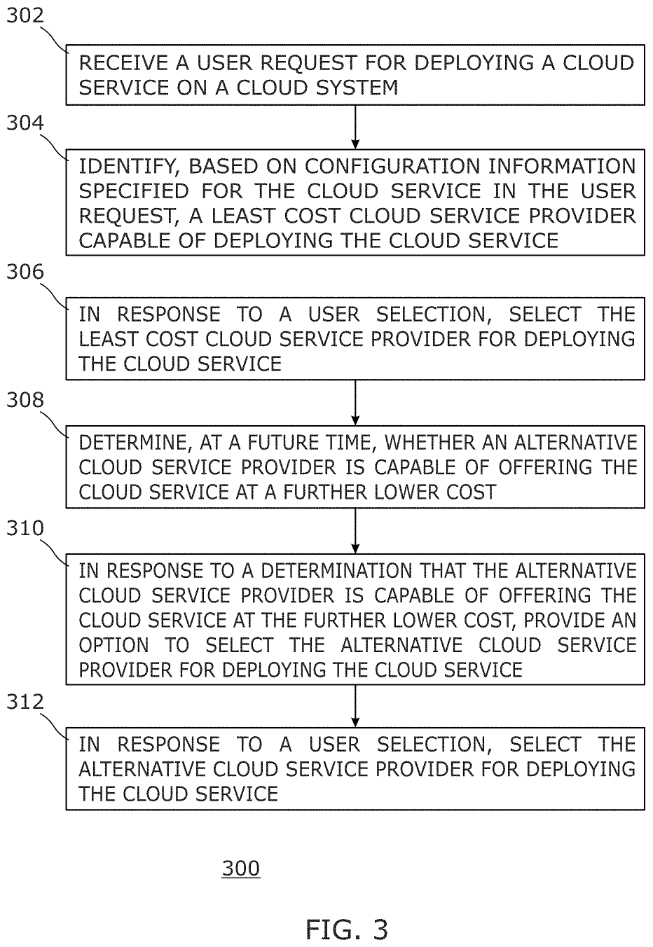

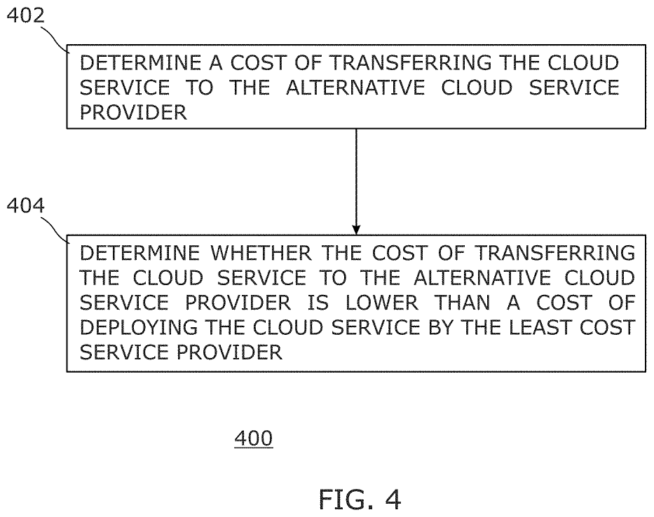

FIG. 3 is a flowchart of an example method 300 of selecting a cloud service provider for deploying a cloud service. The method 300, which is described below, may be executed on a computing system such as 102 of FIG. 1 or 200 of FIG. 2. However, other computing platforms or computing devices may be used as well. At block 302, a user request for deploying a cloud service on a cloud system may be received. At block 304, based on configuration information specified for the cloud service in the user request, a least cost cloud service provider capable of deploying the cloud service may be identified. At block 306, in response to a user selection, the least cost cloud service provider for deploying the cloud service may be selected. At block 308, at a future time, a determination may be made whether an alternate cloud service provider is capable of offering the cloud service at a further lower cost. Referring to FIG. 4, in an example, such determination may include determining a cost of transferring the cloud service to the alternate cloud service provider (block 402) and determining whether the cost of transferring the cloud service to the alternate cloud service provider is lower than the cost of deploying the cloud service by the least cost cloud service provider (block 4014). Referring back to FIG. 3, at block 310, in response to a determination that the alternate cloud service provider is capable of offering the cloud service at a further lower cost, an option to select the alternate cloud service provider for deploying the cloud service may be provided. At block 312, in response to a user selection, the alternate cloud service provider for deploying the cloud service may be selected.

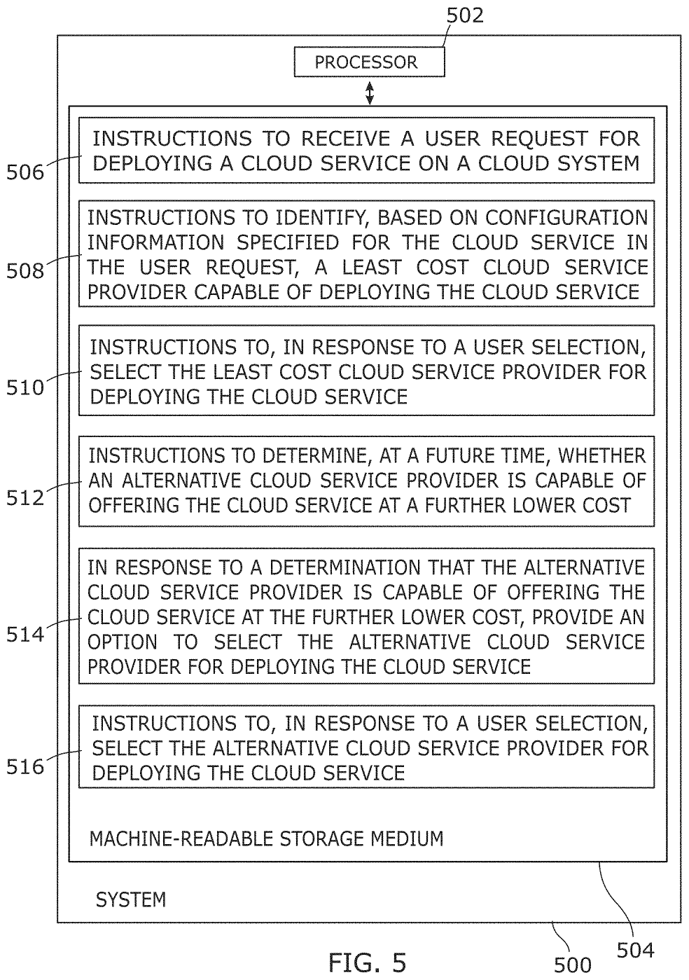

FIG. 5 is a block diagram of an example system 500 including instructions in a machine-readable storage medium to select a cloud service provider for deploying a cloud service. System 500 includes a processor 502 and a machine-readable storage medium 504 communicatively coupled through a system bus. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, 512, 514, and 516. In some implementations, some or all of instructions 506, 508, 510, 512, 514, 516 may be useful for implementing some or all of engines 120, 122, 124, 126, and 128 described above.

In an example, instructions 506 may be executed by processor 502 to receive a user request for deploying a cloud service on a cloud system. Instructions 508 may be executed by processor 502 to identify, based on configuration information specified for the cloud service in the user request, a least cost cloud service provider capable of deploying the cloud service. Instructions 510 may be executed by processor 502 to select the least cost cloud service provider for deploying the cloud service, in response to a user selection. Instructions 512 may be executed by processor 502 to determine, at a future time, whether an alternate cloud service provider is capable of offering the cloud service at a further lower cost. Instructions 514 may be executed by processor 502 to provide an option to select the alternate cloud service provider for deploying the cloud service, in response to a determination that the alternate cloud service provider is capable of offering the cloud service at the further lower cost. In response to a user selection, instructions 516 may be executed by processor 502 to select the alternate cloud service provider for deploying the cloud service.

For the purpose of simplicity of explanation, the example methods of FIGS. 3 and 4 are shown as executing serially, however it is to be understood and appreciated that the present and other examples are not limited by the illustrated order. The example systems of FIGS. 1, 2, and 5, and methods of FIGS. 3 and 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method, comprising:
receiving a user request for deploying a cloud service on a cloud system;
identifying, based on configuration information specified for the cloud service in the user request, a least cost cloud service provider capable of deploying the cloud service;
in response to a user selection, selecting the least cost cloud service provider for deploying the cloud service;
determining, at a future time, whether an alternate cloud service provider is capable of offering the cloud service at a further lower cost;
in response to a determination that the alternate cloud service provider is capable of offering the cloud service at the further lower cost, providing an option to select the alternate cloud service provider for deploying the cloud service; and
in response to a user selection, selecting the alternate cloud service provider for deploying the cloud service.

2. The method of claim 1, wherein determining comprises:
determining a cost of transferring the cloud service to the alternate cloud service provider; and
determining whether the cost of transferring the cloud service to the alternate cloud service provider is lower than a cost of deploying the cloud service by the least cost cloud service provider.

3. The method of claim 2, wherein the cost of transferring the cloud service to the alternate cloud service provider includes a cost of cancelling the cloud service with the least cloud service provider and a cost of deploying the cloud service with the alternate cloud service provider.

4. The method of claim 1, wherein the cloud service includes a virtual machine or a container.

5. The method of claim 1, wherein the cloud service includes a software container.

6. The method of claim 1, wherein identifying comprises:
comparing the configuration information specified for the cloud service in the user request with configuration information of cloud services provided by various cloud service providers; and
identifying the least cost cloud service provider, amongst various cloud service providers, that is capable of deploying the cloud service, considering the configuration information specified in the user request.

7. The method of claim 1, wherein the future time includes a time prior to an expiry of the cloud service deployed by the least cost cloud service provider.

8. A system, comprising:
a receipt engine to receive a user request for deploying a cloud service on a cloud system;
an identification engine to identify, based on configuration information specified for the cloud service in the user request, a least cost cloud service provider capable of deploying the cloud service;
a selection engine to, in response to a user selection, select the least cost cloud service provider for deploying the cloud service;
a determination engine to determine, at a future time, whether an alternate cloud service provider is capable of offering the cloud service at a further lower cost; and
a deployment engine to, in response to a determination that the alternate cloud service provider is capable of offering the cloud service at the further lower cost, provide an option to select the alternate cloud service provider for deploying the cloud service, wherein the selection engine to, in response to a user selection, select the alternate cloud service provider for deploying the cloud service.

9. The system of claim 8, wherein the configuration information includes at least one of processing resources, network resources, and storage resources for the cloud service.

10. The system of claim 8, wherein the future time includes a time after an expiry of the cloud service deployed by the least cost cloud service provider.

11. The system of claim 8, wherein the least cost cloud service provider is one of a public cloud service provider and a private cloud service provider.

12. The system of claim 8, wherein the cloud service includes a software container.

13. A non-transitory machine-readable storage medium comprising instructions, the instructions executable by a processor to:
receive a user request for deploying a cloud service on a cloud system;
identify, based on configuration information specified for the cloud service in the user request, a least cost cloud service provider capable of deploying the cloud service;
in response to a user selection, select the least cost cloud service provider for deploying the cloud service;
determine, at a future time, whether an alternate cloud service provider is capable of offering the cloud service at a further lower cost;
in response to a determination that the alternate cloud service provider is capable of offering the cloud service at the further lower cost, provide an option to select the alternate cloud service provider for deploying the cloud service; and
in response to a user selection, select the alternate cloud service provider for deploying the cloud service.

14. The storage medium of claim 13, wherein the instructions to determine include instructions to:
determine a cost of transferring the cloud service to the alternate cloud service provider; and
determine whether the cost of transferring the cloud service to the alternate cloud service provider is lower than a cost of deploying the cloud service by the least cost cloud service provider.

15. The storage medium of claim 13, wherein the alternate cloud service provider is one of a public cloud service provider and a private cloud service provider.

16. The storage medium of claim 13, wherein the cloud system includes a public cloud system.

17. The storage medium of claim 13, wherein the instructions to identify include instructions to:
compare the configuration information specified for the cloud service in the user request with configuration information of cloud services provided by various cloud service providers; and
identifying the least cost cloud service provider, amongst various cloud service providers, that is capable of deploying the cloud service, considering the configuration information specified in the user request.

18. The storage medium of claim 13, wherein the future time includes one of a weekly time period, a monthly time period, a half-yearly time period, and a yearly time period.

19. The storage medium of claim 13, wherein the future time includes a time after an expiry of the cloud service deployed by the least cost cloud service provider.

20. The storage medium of claim 13, wherein the cloud service includes a virtual machine.
